(19) United States
(12) Patent Application Publication
(10) Pub. No.: US 2016/0019017 A1
(43) Pub. Date: Jan. 21, 2016

(54) Companion Content

(71) Applicant: Comcast Cable Communications, LLC, Philadelphia, PA (US)

(72) Inventors: Todd Walker, Berwyn, PA (US); Charlie Herrin, Wayne, PA (US); Sree Kotay, Philadelphia, PA (US)

(21) Appl. No.: 14/334,735

(22) Filed: Jul. 18, 2014

(51) Int. Cl. G06F 3/14; H04N 5/445; H04N 5/765

(52) U.S. Cl. CPC G06F 3/1423; G06F 3/1446; H04N 5/765; H04N 5/44591

(57) ABSTRACT

Systems and methods are presented that, in some aspects, associate items of content and/or sources of content with companion content and/or sources of companion content. In some aspects, while accessing (e.g., viewing, recording, etc.), a primary item of content, associated companion content may be recorded. The recorded companion content may be later presented in response to, for example, a request to present the recorded item of primary content.

### BACKGROUND

As smartphones and tablet computing devices become more ubiquitous, so-called “second screen” viewing experiences are becoming more common. In a second-screen viewing experience, a user may watch content such as a video program on their television, while also browsing an Internet site. The Internet site may provide supplementary information about the video program (e.g., trivia about cast members, additional back story, etc.), and may also be time synchronized with a scheduled transmission of the video program to, for example, reveal certain information only after certain scenes in the program.

Second-screen experiences are an interesting way to keep viewers engaged, and as the feature becomes more widely adopted, there will be more challenges to provide even more features related to enhanced experiences to improve and help encourage viewer engagement.

### SUMMARY

The following summary is for illustrative purposes only, and is not intended to limit or constrain the detailed description.

Various features herein relate to providing users with greater flexibility and options in receiving and consuming supplemental content, such as second-screen experiences. In one embodiment, a user may request to create an association (e.g., as customized by the user) between particular content (e.g., multimedia content such as audio and/or video content) and/or a particular content source (e.g., web site, network address, video service, channel, etc.) and other particular content and/or content source. The content among which the associations may be made may be any kind of content, including but not limited to video content (with or without audio content), audio content, web site content, graphical content, textual content, image content, advertisements, animation, hyperlinks, data files, live data feeds, device and/or sensor status information, favorite channels, device settings, video games, other software, defined movements of a mechanical device and/or robot, defined inputs to a remote control or other input device, and the like.

In one aspect, particular content, or a source of the particular content, may be associated with other particular content, or a source of the other particular content. For example, a video program may be associated with a web page, and vice-versa. Thus, one item of content in the pair may act as supplemental, e.g., companion, content with the other item. For example, if the viewer accesses one item of the pair, then the viewer may also be presented with the other item of the pair as companion content, and vice-versa. In further examples, more than two items of content may be associated with one another, such as three items, four items, or more. In this case, when one of the items is accessed, then one or more of the others in the groups of associated items of content may also be presented to the user, and/or otherwise accessed, as companion content.

For convenience of explanation, an item of content and/or a content source that is requested by a user to be accessed (e.g., a video program, a web site, etc.) will be referred to as primary content, and any content and/or content source determined to be associated with the requested content and/or content source will be referred to as companion content. However, any items in a group of associated items of content and/or content sources may be considered primary content or companion content, depending upon which item of content and/or content source was requested by the user to trigger the determination of associated items of content and/or associated content sources as the companion content. For instance if a first item of content and a second item of content are associated with each other, then when a user requests to view the first item of content, the second item of content may be referred to as the companion content. Likewise, if the user requests to view the second item of content, the first item of content may be referred to as the companion content in that context. In some cases, the associations between two or more items of content and/or content sources in a group may be bi-directional and equal (each item is associated with each of the one or more other items in the group). In other cases, one or more of the associations may not be bi-directional (e.g., a second item of content is companion content for a first item of content, but not vice-versa).

A computing device (e.g., the consumer's video consumption device, a network server, etc.) or system of computing devices may store association information for the consumer, indicating the association between the two or more items of content and/or content sources (e.g., primary content and/or content source associated with companion content and/or content source). Then, for example, the next time the user requests or begins to consume an item of content (e.g., tunes to, plays, records, or otherwise consumes the content and/or content source, such as a video program, video service, service, television channel, program series, movie, etc.), the one or more computing devices may use the association information to determine one or more associated items of companion content and send an instruction to cause the one or more associated items of content to be accessed (e.g., presented to the user) along with the primary content (or access/present the companion content through one of the one or more computing devices).

In some embodiments, the companion content may be displayed or otherwise presented to the user on the same device or screen as the device or screen used to consume the video content. In other embodiments, the companion content may be presented to the user using a second device and/or on a different screen different from device and/or screen used to consume the video content. For example, a user's tablet computer can be the second device on which the companion content is presented, different from a first device such as the user's living room television on which the primary content is consumed.

In some embodiments, the association between the primary content and the companion content may be created responsive to the user selecting an option or a particular command, for example, in a web environment using an Internet browser of a computing device (e.g., where the user is browsing an Internet web site as the companion content). Alternatively, the association can be requested while the user is watching the video content—for instance, the user may press a button on a remote control to initiate an onscreen dialog to create an association between the currently-consumed primary content (e.g., currently-viewed video content such as the television channel, the specific program episode, or series being viewed) and one or more items of companion content (e.g., one or more Internet web sites). In still further embodiments, the association may be requested by the user between the primary content and the companion content even though the primary content itself may not be currently consumed by (e.g., viewed by, listened to by, or otherwise presented to) the user, such as during interaction with a program guide, menu, or other user interface indicating the primary content.

When the user creates the association using an Internet browser command, for example, the user's browser software may obtain and display, or otherwise cause to be obtained and displayed, a listing of items of primary content (e.g., video programs and/or program providers) and/or a listing of sources of primary content. The browser software may provide the user with the opportunity to select one or more of the listed items to associate with a currently-browsed or otherwise selected Internet web site or other source of supplemental content. The associations may be between, for example, one or more different Internet sites (or any other one or more sources of supplemental content) and primary content such as a program series, individual episodes of the program series, a movie, a particular program, a particular program provide or other content service (e.g., NBC), a content source, a creator of the primary content, etc. In some embodiments, different episodes of the same video program series may be each associated with a different content source or different set of content sources.

The user may associate one or more different items of secondary, e.g., companion, content with a single item of primary content. To support such an association, the one or more computing devices may, for example, store data associated with an item of primary content that identifies one or more associated items of companion content and/or sources thereof (e.g., by URL, IP address, or other network address; by title; by program ID; and/or by other unique identifier, etc.), as well as presentation data identifying an arrangement on a display screen for presenting the one or more items of companion content. The presentation data may be selected by the user or automatically and may identify the arrangement of, for instance, one or more browser panels showing the one or more Internet sites as the one or more items of companion content. For example, the presentation data may indicate that one associated item of content or source of content should be displayed in the upper-left corner of a device's display (e.g., a tablet computer), another associated item of content or source of content should be simultaneously displayed in the lower-left corner of the display, and a third associated item of content or source of content should be simultaneously displayed on the right half of the display. The presentation data, in this example, may identify how the various panels are arranged on the user's display, so that the next time the user consumes the associated primary content, the same arrangement of companion content (in this example, multiple Internet sites) may be automatically presented in the portions of the display that are identified by the presentation data.

In some embodiments, consuming (e.g., playing, viewing, tuning to, accessing, etc.) an item of primary content for display may automatically cause the one or more items of associated companion content to also be consumed (e.g., played, viewed, accessed, downloaded, recorded, etc.) and/or one or more associated companion content sources to be accessed (e.g., browsed to, tuned to, etc.). The opposite may be true as well—consuming an item of companion content for display (and/or accessing a companion content source) may automatically cause the associated primary content to also be presented or otherwise consumed (and/or the associated primary content source to be accessed). For example, when the user tunes a video device to a video program (as the primary content), supplemental content from a content source, such as an Internet site, associated with the video program may be automatically displayed on that device and/or on another device (and may be automatically displayed in accordance with the presentation data for that video program). Similarly, when the user uses a browser on a device or other software to access the content source (e.g., the Internet site) as the supplemental content associated with particular video content as the primary content (e.g., a particular video program, series of programs, content service, etc.), the browser or other software may automatically cause, or otherwise send a signal to cause, the device or another device to tune to or otherwise access the associated video content (e.g., tune to the particular video program, to one of the series of programs, or to the content service such as NBC).

In some embodiments, the association between primary content and companion content may be used when recording primary content, even if the primary content is not being currently displayed. For example, in response to the user requesting to record a video program, the user's computing device may provide an option to record the one or more Internet sites that the user identified as being associated with the video program. The computing device may then retrieve, or otherwise cause retrieval of, the Internet site(s) when the video program recording begins, and thus may archive a version of the Internet site(s) that is contemporaneous with the video program recording. The retrieval and archiving may be performed once during the recording (or viewing) or multiple times, such as periodically, during the recording or viewing to produce multiple archived versions of the Internet site(s) over time. Similarly, the user may manually request to archive an Internet site, and in response, the one or more computing devices may automatically schedule a recording of the video program associated with the Internet site. The term “archive” as used herein can broadly include any type of storage of content for subsequent retrieval, including but not limited to recording video content, storing other types of data, obtaining an image (e.g., snapshot) of video, a web site, or other content, generating an storing a summary or abstract of the content, generating a thumbnail of the content, recording audio of content that may or may not include video or other types of media, and/or storing data, such as metadata, associated with the content being archived.

As another example, when the user requests to play back a previously-recorded item of primary content (e.g., a previously-recorded video program) on a first device, the one or more computing devices may provide the user the opportunity to also be presented with the associated companion content, such as an associated Internet site. The one or more computing devices may further provide the user with a selectable option to be presented with either a current version of the associated Internet site or an archived version that was retrieved contemporaneously with the recording of the video program as described above. Thus, the companion content may be a current version of content and/or an archived past version of the content. Similarly, when the user uses a browser of a device to access an Internet site that is associated with a video program recording, the browser may cause, or send a command to cause, the associated recording to automatically begin playback on the device or another device.

The associations between primary and companion content may be indicated to the user, such as being presented as part of an interface, such as an electronic program guide (EPG) or other content guide. The associations may be customized for individual users, such that when the content guide indicates that an item of content is associated with one or more Internet sites, the content guide may also indicate which user(s) have the listed association.

In some embodiments, a device remote control may include a command button that, when selected, causes the one or more computing devices to automatically create an association between a currently-viewed item of primary content with a currently-viewed item of companion content. The command button (or another button) may additionally or alternatively cause, when selected, the one or more computing devices to present the associated companion content while the primary content is being presented, and/or to present the associated primary content when the companion content is being presented.

The associations may be made with any type of primary content such as, but not limited to, program series, individual episodes of a program series, and/or a program provider such as a television station. The primary content need not be video, as audio programs may also be associated. Additionally, while the examples above associate the primary content with one or more Internet sites, the association can be with other types of companion content or other items. For example, the user can create a custom association between a video program (as the primary content) and another video program, a software application (as the companion content) on the user's tablet computer, or the user's home security system (as a companion item) and/or information about the user's home security system such as a system status (as companion content).

In some embodiments, a user may create multiple distinct associations when viewing or otherwise accessing a given item of primary content, and when subsequently viewing or otherwise accessing the primary video content, the user may be given an option to select one or more of the previously-created associations. The associations may also be shared with other users (e.g., friends), such that when those other users access the primary content, then the associated companion content may also appear to those other users (e.g., on those other user's devices).

Thus, for example, some aspects as described herein are directed to establishing an association between a first item of content and a second item of content, and receiving and storing a first version of the second item of content. Responsive to a user request for the first item of content after the receiving and storing are performed, the method may further include causing both the first item of content and the first version of the second item of content to be presented.

Further example aspects as described herein are directed to establishing an association between a first item of video content and a web site, and recording the first item of video content. First content may be obtained from the web site while the first item of video content is being recorded. Responsive to a user request for the first item of video content, both the first item of video content that was recorded and the first content may be caused to be presented.

Still further example aspects as described herein are directed to responsive to generating profile information associating a web site and video content identified by and in response to a user input that identifies the video content to be associated with the web site. In response to browsing the web site the profile information may be used to obtain the video content, and the video content that was obtained may be caused to be presented.

The summary here is not an exhaustive listing of the novel features described herein, and is not limiting of the claims. These and other features are described in greater detail below.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 illustrates an example system in which various features described herein may be implemented in accordance with one or more aspects as described herein.

FIG. 2 illustrates an example computing device that can be used to implement any of the methods, servers, entities, and elements discussed herein and shown in the figures, in accordance with one or more aspects as described herein.

FIGS. 3A and 3B illustrate an example process that may be performed in accordance with one or more aspects as described herein.

FIGS. 4-7 illustrate example user interfaces that may be presented, in accordance with one or more aspects as described herein.

FIG. 8 illustrates an example remote control device that may be used in accordance with one or more aspects as described herein.

FIG. 9 illustrates an example timeline for recording and archiving various content, in accordance with one or more aspects as described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be used, and structural and functional modifications may be made, without departing from the scope of the present disclosure.

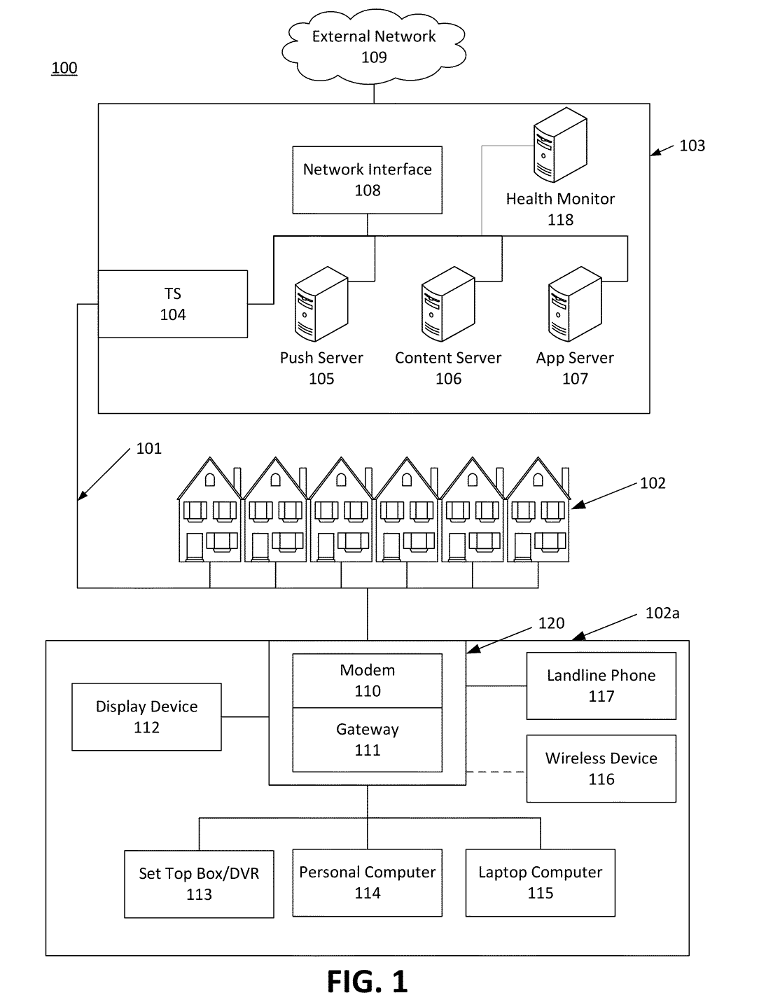

FIG. 1 illustrates an example communication network 100 on which many of the various features described herein may be implemented. Network 100 may be any type of information distribution network, such as satellite, telephone, cellular, wireless, etc. One example may be an optical fiber network, a coaxial cable network, or a hybrid fiber/coax distribution network. Such networks 100 use a series of interconnected communication links 101 (e.g., coaxial cables, optical fibers, wireless, etc.) to connect multiple premises 102 (e.g., businesses, homes, consumer dwellings, etc.) to a local office or headend 103. The local office 103 may transmit downstream information signals onto the links 101, and each premises 102 may have a receiver used to receive and process those signals.

There may be one link 101 originating from the local office 103, and it may be split a number of times to distribute the signal to various premises 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths.

The local office 103 may include an interface, such as a termination system (TS) 104. More specifically, the interface 104 may be a cable modem termination system (CMTS), which may be a computing device configured to manage communications between devices on the network of links 101 and backend devices such as servers 105-107 (to be discussed further below). The interface 104 may be as specified in a standard, such as the Data Over Cable Service Interface Specification (DOCSIS) standard, published by Cable Television Laboratories, Inc. (a.k.a. CableLabs), or it may be a similar or modified device instead. The interface 104 may be configured to place data on one or more downstream frequencies to be received by modems at the various premises 102, and to receive upstream communications from those modems on one or more upstream frequencies.

The local office 103 may also include one or more network interfaces 108, which can permit the local office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the network interface 108 may include the corresponding circuitry needed to communicate on the external networks 109, and to other devices on the network such as a cellular telephone network and its corresponding cell phones.

As noted above, the local office 103 may include a variety of servers 105-107 that may be configured to perform various functions. For example, the local office 103 may include a push notification server 105. The push notification server 105 may generate push notifications to deliver data and/or commands to the various premises 102 in the network (or more specifically, to the devices in the premises 102 that are configured to detect such notifications). The local office 103 may also include a content server 106. The content server 106 may be one or more computing devices that are configured to provide content to users at their premises. This content may be, for example, video on demand movies, television programs, songs, text listings, etc. The content server 106 may include software to validate user identities and entitlements, to locate and retrieve requested content, to encrypt the content, and to initiate delivery (e.g., streaming) of the content to the requesting user(s) and/or device(s).

The local office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for user interface (e.g., electronic program guide) listings. Another application server may be responsible for monitoring user viewing habits and collecting that information for use in selecting advertisements. Yet another application server may be responsible for formatting and inserting advertisements in a video stream being transmitted to the premises 102. Although shown separately, one of ordinary skill in the art will appreciate that the push server 105, content server 106, and application server 107 may be combined. Further, here the push server 105, content server 106, and application server 107 are shown generally, and it will be understood that they may each contain memory storing computer executable instructions to cause a processor to perform steps described herein and/or memory for storing data.

An example premises 102a, such as a home, may include an interface 120. The interface 120 can include any communication circuitry needed to allow a device to communicate on one or more links 101 with other devices in the network. For example, the interface 120 may include a modem 110, which may include transmitters and receivers used to communicate on the links 101 and with the local office 103. The modem 110 may be, for example, a coaxial cable modem (for coaxial cable lines 101), a fiber interface node (for fiber optic lines 101), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. Further, the interface 120 may include a gateway interface device 111. The modem 110 may be connected to, or be a part of, the gateway interface device 111. The gateway interface device 111 may be a computing device that communicates with the modem(s) 110 to allow one or more other devices in the premises 102a, to communicate with the local office 103 and other devices beyond the local office 103. The gateway 111 may be a set-top box (STB), digital video recorder (DVR), computer server, or any other desired computing device. The gateway 111 may also include (not shown) local network interfaces to provide communication signals to requesting entities/devices in the premises 102a, such as display devices 112 (e.g., televisions), additional devices 113 (e.g., STBs and/or DVRs), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

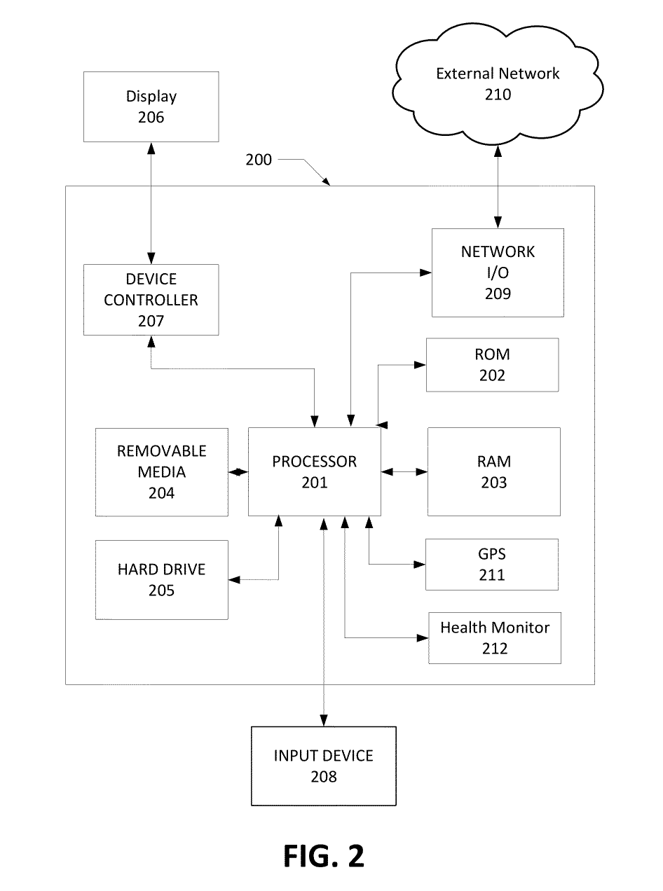

FIG. 2 illustrates general hardware and software elements of an example computing device 200 that may be used to implement any of the various elements discussed herein and shown in the figures. The computing device 200 may include, for instance, one or more processors 201, which may execute computer-readable instructions of a computer program to perform, or otherwise cause to occur, some or all of the features described herein. The instructions may be stored in any one or more types of computer-readable media to configure the operation of the processor 201. For example, the instructions may be stored in one or more memory chips (e.g., a read-only memory (ROM) 202 and/or a random access memory (RAM) 203), a hard disk drive, removable storage media 204 (such as a Universal Serial Bus (USB) drive, FLASH drive, compact disk (CD) or digital versatile disk (DVD), or floppy disk drive), and/or any other desired storage medium. Instructions may also be stored in an attached (or internal) hard drive 205. The computing device 200 may include one or more output devices, such as a display 206 (e.g., an external television) or multiple displays, and may include one or more output device controllers 207, such as a video processor. The computing device 200 may also include or be coupled with one or more user input devices 208, such as a remote control, keyboard, mouse, touch screen, microphone, video camera, etc. The computing device 200 may also include one or more network interfaces, such as a network input/output (I/O) circuit 209 (e.g., a network card) to communicate with an external network 210. The network input/output circuit 209 may be a wired interface, wireless interface, or a combination of the two. In some embodiments, the network input/output circuit 209 may include a modem (e.g., a cable modem), and the external network 210 may include the communication links 101 discussed above, the external network 109, an in-home network, a provider's wireless, coaxial, fiber, or hybrid fiber/coaxial distribution system (e.g., a DOCSIS network), or any other desired network. Additionally, the device may include a location-detecting device, such as a global positioning system (GPS) microprocessor 211, which can be configured to receive and process global positioning signals and determine, with possible assistance from an external server and antenna, a geographic position of the device.

Modifications may be made to add, remove, combine, divide, etc. components of the computing device 200 as desired. Additionally, the components illustrated may be implemented using basic computing devices and components, and the same components (e.g., processor 201, ROM storage 202, display 206, etc.) may be used to implement any of the other computing devices and components described herein. For example, the various components herein may be implemented using computing devices having components such as a processor executing computer-executable instructions stored on a computer-readable medium, as illustrated in FIG. 2. Some or all of the entities described herein may be software based, and may co-exist in a common physical platform (e.g., a requesting entity can be a separate software process and program from a dependent entity, both of which may be executed as software on a common computing device).

One or more aspects of the present disclosure may be embodied in the form of, or otherwise utilize, computer-usable data and/or as computer-executable instructions, such as in one or more program modules, executed by one or more computing devices. Generally, program modules may include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

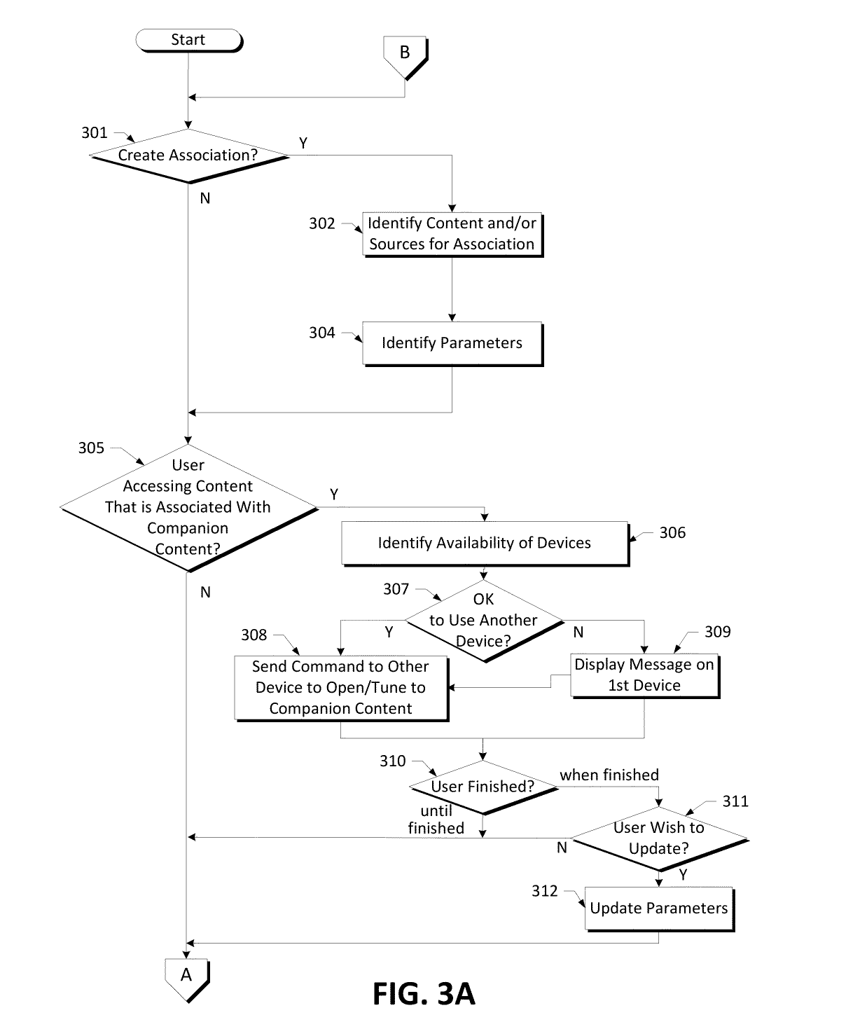

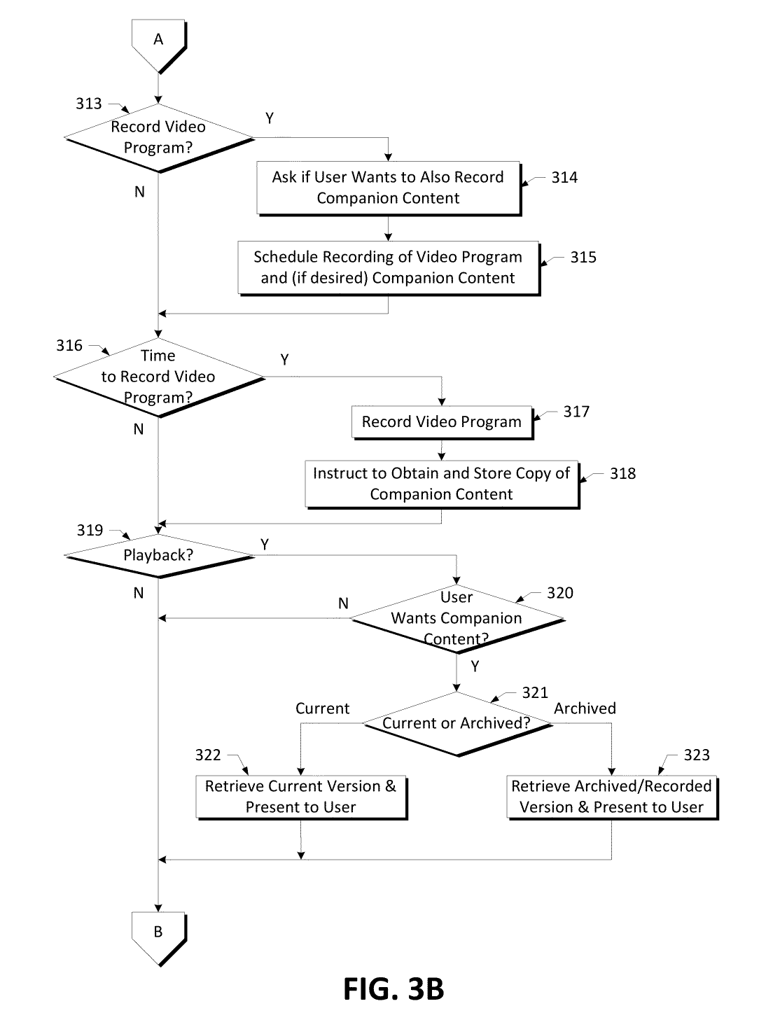

FIGS. 3A and 3B illustrate an example process that may be performed in accordance with one or more aspects as described herein. The steps in the process may be variously performed by, for instance, any one or more of the elements shown in and/or described with reference to FIG. 1, in any combination. While certain steps of FIGS. 3A and 3B may be described with reference to particular elements that may perform those steps, such description is merely illustrative. Any of the steps of FIGS. 3A and 3B may be performed by any one or more elements, for example, element(s) at a service provider side (e.g., application server 107) and/or element(s) at the user side such as by a user device (e.g., any of elements 110-117).

A user, such as a user at premises 102a, may choose to view certain content. The content may be, for example, video content such as scheduled video programs, on-demand video content, pay-per-view video content, and/or locally-stored (e.g., recorded) video content. The content may alternatively be audio content without video. To view and/or hear the video and/or audio content (referred to herein by way of example as the primary content), the user may, for instance, tune to the primary content using the device 113 or otherwise access the primary content using the personal computer 114, the laptop computer 115, or the wireless device 116. The primary content may be provided, e.g., via communication line 101, and may be provided to the user's device such as by a cable provider, satellite provider, Internet web site provider, and/or the like. For example, the user may tune the device 113 to a particular channel to view the content on the display device 112. Or, the user may use the wireless device 116, such as in the form of a tablet computer or smart phone, to view the content using a video viewing application executed by the wireless device 116.

Alternatively, the user may choose to browse to a particular web site, such as by using an Internet browser software application. The browser may be implemented on any computing device, such as the personal computer 114, the laptop computer 115, or the wireless device 116. The web site (referred to herein by way of example as the companion content) may be any web site such as one hosted on the Internet or on an intranet or other local network or device. The web site may be partially or fully implemented in the form of, for example, hypertext markup language (HTML) and/or other appropriate languages, which may be interpreted by the browser of the user's device for displaying to the user.

In either case (viewing a video program or browsing a web site), the user may desire to associate another item of content with the video program or the web site. Examples of both of these cases will be described with reference to the steps of FIGS. 3A and 3B.

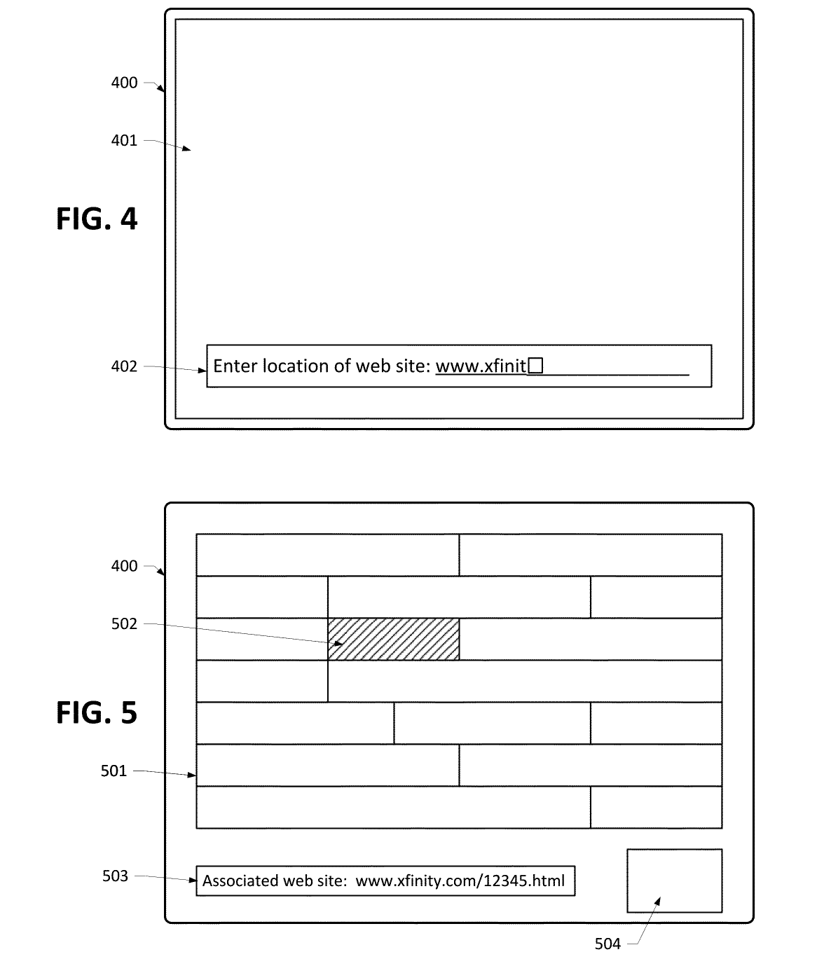

In the case where the user wishes to identify a web site for association with video content (step 301), this may be done while the user is viewing the video content and/or otherwise using a user interface through which the video content can be accessed. For example, if the user is currently watching the video content or tuned to a channel (e.g., a TV channel) showing the video content, then the user may wish to associate the video content or the channel being watched with a web page. This may be done through, for instance, the device and/or user interface on which the user is viewing or otherwise accessing the video content. For example, FIG. 4 shows an example user interface displayed by a display 400 of a user device on which video content 401 is being displayed. In response to a command, the user interface may show a prompt 402 asking the user to enter the location of a web site to be associated with the video content. The prompt may also ask whether the user would like to associate the web site with only the video content, with a series of programs related to the video content (e.g., where the video content is one of the programs in the series), and/or with the channel or other service (e.g., NBC) that provides the video content.

The association with a web page may also be made using another interface such as an electronic program guide. An example of such a user interface is shown in FIG. 5. The user interface may be formatted in any of a number of ways, such as in the form of a grid guide (time versus channel/service), a tile guide (where each tile represents a video program or a channel/service), etc. In the example of FIG. 5, the user interface includes a grid program guide, with each block in the grid representing a different video program, the horizontal axis representing time, and the vertical axis representing different channels/services. A particular block (or, in the case of a tile guide, a tile) may be selected for further information about the associated video program and/or channel/service. In this example, block 502 is selected, with the selection being shown as a highlighting of block 502. In response to the selection, the program guide or other user interface may show information 503 about the video program or channel/service, including what web site is currently associated with the video program or channel/service. The program guide or other user interface may also include a preview 504 (e.g., a screen shot) of the associated web site. The preview 504 may be a current state of the web site (e.g., by actively retrieving a current version of the web site) or a pre-stored past version of the web site.

Selecting the displayed information 503 or the preview 504 may cause a browser to browse to the web site. Where the device showing the user interface is capable of executing a browser, the web site may be shown on the same device. Alternatively, selecting the information 503 or the preview 504 may cause a browser on a different user device to browse to the associated web site. To accomplish this, the device displaying the user interface and/or the service provider (e.g., using server 107) may send a message to the other device requesting that it browse to the identified web site.

In further examples, the interface may provide some visual indication (e.g., by highlighting, using an icon, using a different font and/or text style, etc., to indicate which of the programs identified in the interface have companion content. In the present disclosure, any reference to companion content includes not only companion content items (such as video programs, video clips, audio programs, broadcasts, multicasts, unicasts, streamed video, streamed audio, etc.), but also companion content sources (such as web sites, channels, video services, etc.). Using such an interface, for example, the user may be able to understand, at a glance, which of the programs listed in the interface have companion content, and which don't. Selecting one of the listed video programs may allow the user to see more information about the companion content, such as the information provided in FIG. 5 and/or other information, as well as provide the user an opportunity to edit/modify the companion content and/or the parameters for the companion content. Where a channel has companion content, then the indication of the channel itself may be visually distinguished (such as in any of the manners mentioned above) to show the user that the channel has companion content. Where a program series has companion content, then each instance of a program in the series may likewise be visually differentiated to indicate to the user that companion content exists. In still further examples, the user may be able to obtain a user interface screen in which all programs, channels, and/or program series, etc., are listed along with their associated items of content. Such a listing may allow the user to see all of the associations at once and provide the user an opportunity to edit the associations as desired.

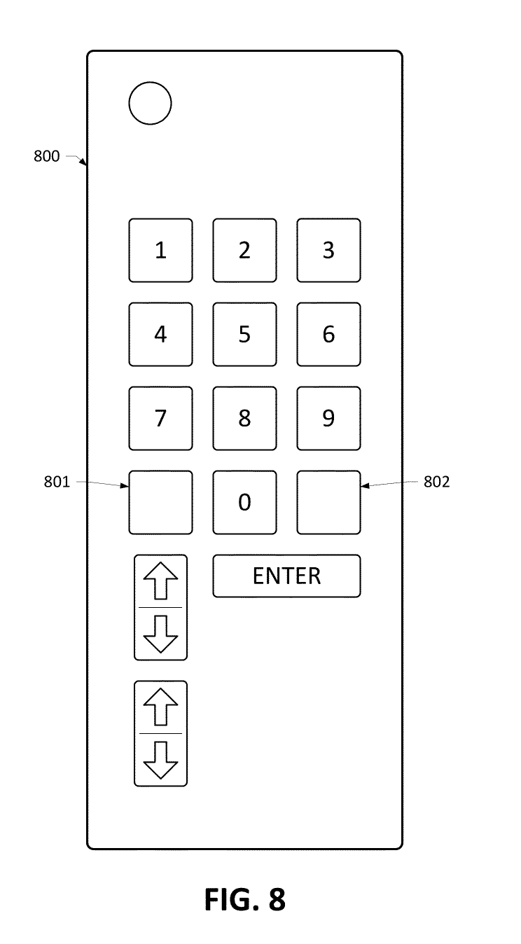

The user may also request the association with a web page through the interface. For instance, the user may highlight block 502 and send a command to the device presenting the interface to initiate an association routine in which the user is presented with the opportunity to enter the location of a web site to be associated with the video content and/or channel/service for block 502. The command may be initiated by the user via the user interface or via a remote device. For example, where the interface or content is being displayed on touch-screen display, the user may touch a portion of the display that may, in turn, cause the prompt 402 to appear or otherwise initiate the association with a web site. Or, the user may utilize a remote control device such as the remote control 800 shown in FIG. 8. A particular command button (e.g., button 801) of the remote control 800 may be dedicated to or otherwise used for initiating the association.

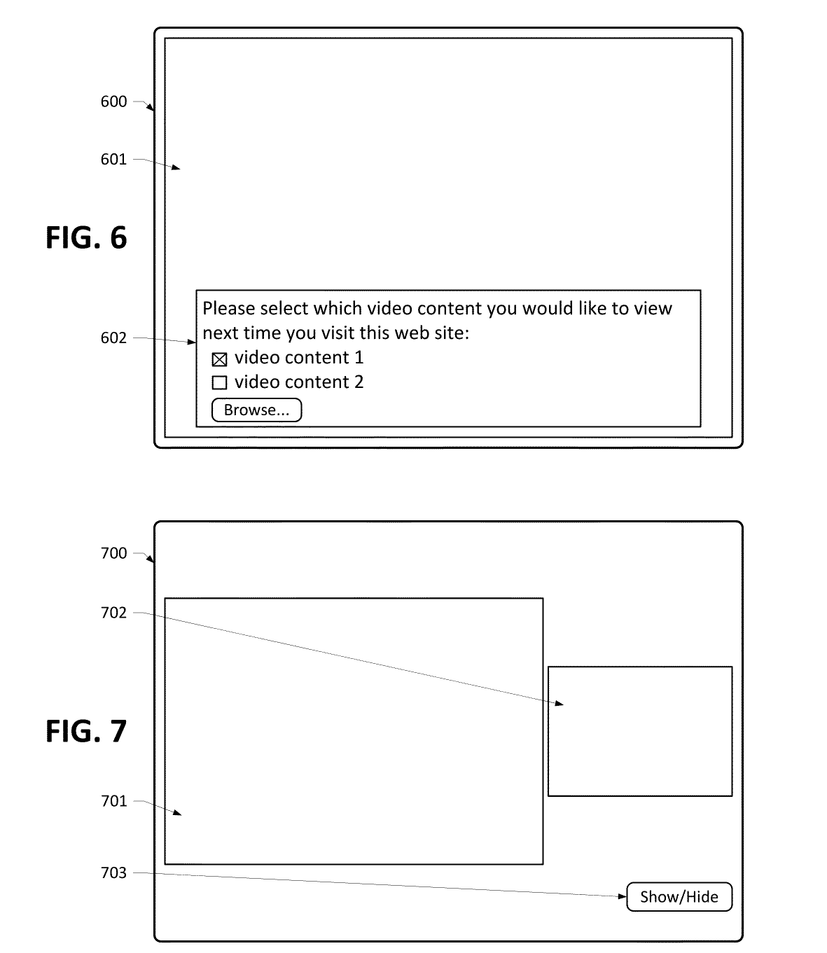

In the alternative case where the user wishes to identify video content or a channel/service for association with a web site (step 301), this may be done while the user is browsing the web site and/or otherwise using a user interface through which the web site can be accessed. This may be done using, for instance, the browser itself. For example, FIG. 6 shows a user interface displayed on a display 600 of a user device, which includes a displayed web page 601 currently being browsed. In response to a command by the user (or automatically without such a command), the user may be presented with a displayed prompt 602 that provides the user with the opportunity to select one or more items of video content and/or one or more channels/services to associate with the web site. In some cases, there may be one or more proposed items of video content and/or channels/services that the user may select. These proposed items may be indicated by the web site itself, such as by including the information in the HTML code of the web site. The user may additionally or alternatively browse for video content or channel/service. If the user chooses to browse for these, the user may send a user command (such as by pressing a “browse” button displayed on the user interface), which may cause a user interface (e.g., a program guide or other listing) to be displayed to the user. The interface may be presented on the same device as the web browser or on a different device that communicates with the device having the web browser. The user may then select one or more pieces of content identified by the interface, such as a television program or series, to create one or more associations using the interface.

Thus, using, for example, any of the above techniques, a user may identify at step 302 one or more items of video content and/or sources of content, such as one or more video content series, channels/services, web sites, and/or other content and/or content sources that should be associated with one another.

Upon identifying the appropriate content and/or content sources to be associated with one another, association information may be created and/or updated to reflect the associations. An example of such association information is shown below in Table 1. While the information is presented below in tabular form, the information may be organized in any form desired to indicate an association between two or more elements (e.g., between video content and a web site). As shown in Table 1, the association information may also include other information such as parameters, as will be discussed below.

TABLE 1

| | CONTENT | CONTENT | CONTENT | PARAM- |
|---|---|---|---|---|
| USER | 1 | 2 | 3 | ETERS |
| user A | video program A | source A | | parameter set A |
| | | (e.g., web | | |
| | | site A) | | |
| user A | video program B | source B | source C | parameter set B |
| user B | video program A | channel A | | parameter set C |
| user C | program series A | source D | | parameter set D |
| user A | channel B | source E | | parameter set E |

In the example of Table 1, video program A is associated with source A (and, vice-versa; source A is associated with video program A). As can also be seen, content and/or a source of content may be associated with one, two, or more other items of content and/or sources of content (e.g., web sites), such as video program B, source D, and source E being associated with each other. Moreover, as indicated in Table 1, for example, each association may be associated with a given user (e.g., user A, user B, user C, etc.). As will be described further below, viewing or otherwise accessing one of the items may cause an associated one or more of the items to also be displayed or otherwise accessed. For instance, if video program A is viewed, then in response, source A (e.g., a web site A) may be automatically accessed (e.g., obtained and displayed) on the same or a different device in accordance with the associated parameters. Likewise, if web site A is browsed to, then in response, video program A may be automatically accessed (e.g., displayed, recorded, downloaded, streamed, etc.) on the same or a different device in accordance with the associated parameters.

The parameters may include one or more substantive parameters (e.g., user login credentials for a website or other source, source-specific settings, etc.), general presentation parameters (e.g., layout and arrangement of the browser window on the user's second screen device—e.g., the user wants content from source A to be in the upper-left corner, content from source B to have the right half of the screen, etc.; and/or which device should be used to display and/or access which companion content, etc.); behavior parameters (e.g., does the user want to automatically tune to the show when the browser hits the associated site and/or automatically open the site when tuning to the show?); and parameters that identify to which users an association should apply (e.g., Dad associates football with the ESPN fantasy football site, while Mom associates football with a different site that she prefers to browse while football is on).

At step 304, one or more of the parameters for the selected association, such as those discussed above, may be identified by the user and/or automatically. For example, upon selecting certain items to be associated (e.g., upon selecting a web site to be associated with video content or vice-versa), the user interface in which the selection is made may also provide the user with the opportunity to enter and/or modify one or more of the parameters for the association. In some cases, one or more of the parameters may be automatically selected, such as being set to a default setting, without user intervention. The default setting may be global or it may be based on a predetermined user profile for the user and/or device.

After the association has been established in steps 301-304, the user may later decide to select, access, and/or consume content and/or a content source (e.g., open an application, browse to a web site such as by clicking on a hyperlink to the web site, typing in the web site address, or selecting a bookmark of the web site, etc.) or view an item of video content (e.g., by selecting the video content from a program guide or other interface, changing the channel on a television viewing device, or selecting a pre-recorded item of video content such as from a DVR). In that case, at step 305 the selecting, accessing, and/or consuming may be detected, for example, such as by the device on which the browsing or viewing is occurring or by an associated device. For example, to view the video content, the user may change the channel (e.g., on device 113) for viewing on the display device 112, or the user may select a video program via the wireless device 116 for viewing on the wireless device 116. Or, to browse to the web site, the user may use a web browser implemented on, e.g., the wireless device 116 or the device 113.

Also at step 305, a device may determine whether the source and/or content being accessed, consumed, and/or selected (e.g., a web site being browsed, video content being viewed, etc.) is associated with another item of content and/or another source of content. For instance, referring to the example association information of Table 1, if the user accesses content source A (e.g., browses to web site A), then at step 305 it may be determined (by referring to the association information) that video program A is associated with the browsed web site. Or, if the user views video program A, then at step 305 it may be determined (again, by referring to the association information) that web site A is associated with the viewed video content. For purposes of the present example, the device on which the web site is being browsed or on which the video content is being viewed will be referred to herein as a first device, and may be the one making the determinations above. As will be described, any companion content may be also displayed on the first device and/or on a different second device. A particular user, household, etc., may have more than one device on which web sites may be browsed and/or video content may be viewed. Accordingly, the profile information mentioned previously may also identify those devices.

If it is determined that the content source being accessed or the item of content being viewed is associated with another item of content and/or another content source, then the process may move to step 306, in which it is determined which of the user's other devices (e.g., those identified in the profile information) are currently being used. For example, if the user is browsing a web site on personal computer 114, the computer (or other computing device providing the service described herein) may determine whether one or more others of the devices such as device 113 and/or wireless device 116 is being used. Rather than checking the use status of all devices identified by the profile information, only one of the devices may be determined for use status such as a device identified in the above discussed parameters. For instance, if the user is browsing web site A, parameter set A may indicate that video content A is to be preferably displayed on a particular device, and that particular device may be the only (or first) one whose status is checked.

At step 307, based on the outcome of the determination of step 306, or without step 306 being performed, it may be determined whether it is okay to use the particular identified device, or another one of the user's devices, to display the companion content. The determination of step 307 may also involve checking the parameters to see whether it is okay to automatically display and/or otherwise access the companion content or whether the user should be prompted first. This may be done, for example, by consulting a database of criteria that the user may have provided when configuring the system, where the criteria my identify content types, devices, times of day, etc. for which companion content is permitted (or not permitted) to be provided; or by providing a query to the user of the identified device to request authorization for an interruption. Based on the determination of step 307, it may be determined what device should be used to display the companion content. This may be the same first device or a different second device. If it is determined that the companion content should be displayed on the second device but it is not yet okay to do so (e.g., because a user of the second device might be undesirably interrupted), then the process may move to step 309, in which a prompt or other message may be displayed on the first device and/or the second device requesting the user's permission to display the companion content on the second device, and/or warning that the companion content is about to be displayed on the second device and/or accessed by the second device. Alternatively, the message may indicate that the companion content is not available and/or provide an option for the user to select another device on which to display and/or otherwise access the companion content. The process may move to step 308 as appropriate to send a command to the other device to access (e.g., open, tune to, browse to, download, etc.) the companion content. Or, if the companion content is to be displayed on the same first device, then the companion content may be accessed by the first device at step 308.

If it is determined at step 307 that it is okay to display or otherwise access the companion content on the second device (e.g., where the second device is idle) or that the companion content is to be displayed on the same first device, then the process may move from step 307 to step 308. Again, if the companion content is to be displayed on the same first device, then the companion content may be accessed by the first device. If the companion content is to be displayed on the second device, then the companion content may be accessed by the second device. Another possibility is that, when companion content is to be displayed on the second device, the companion content may be accessed by the first device or another device and transmitted to (e.g., streamed or downloaded to) the second device for display.

An example of how content and companion content may be displayed on the same device (e.g., the same display) is shown in FIG. 7. In this example, the display 700 may include a window or other screen portion containing the primary content 701 simultaneously with a window or other screen portion containing the associated companion content 702. In the shown example, content 701 and companion content 702 are displayed side-by-side without overlap. However, in alternative arrangements, one may partially or fully overlap the other, with some or no transparency. For instance, the display 700 may be arranged in a picture-in-picture (PiP) format such that displayed content 702 is in a smaller window within displayed content 701, or vice-versa. Moreover, an especially where there is overlap, one or the other of content 701, 702 may take up the entire display frame of display 700, if desired, rather than only a portion thereof. The display 700 may also present an option to toggle between showing and hiding the associated displayed content 702, such as in the form of a show/hide toggle virtual button 703. Where the content 701 is a video program (for instance), then the content 702 may be an associated web site (for instance). Where the content 701 is a web site (for instance, where display 700 is showing a browser screen), then the content 702 may be an associated video program (for instance). However, any combination of content and companion content may be presented, as desired. Moreover, the particular layout of the content 701 and the content 702 on the display 700 may be partially or fully defined by the parameters in the association information, described in more detail below. Regardless of the particular layout, the user may alternatively or additionally toggle between showing and hiding the companion content 702 with input from the remote control 800 (FIG. 8), for instance by pressing a button 802 on the remote control 800. In further embodiments, the toggle may be between presenting the companion content 702 on the same display and/or device as the content 701 and presenting the companion content 702 on a different display and/or device.

If the user has finished browsing the web site (e.g., by closing the browser window or browsing to a different web site) or viewing the video content on the first device, then at step 310 this may be detected and the process may move to step 311. Unless and until that occurs, the process may move to step 313 (FIG. 3B). If, at any time, the user has finished browsing the web site or viewing the video content on the first device, then the process may return to step 310 to detect this occurrence and then move to step 311. Also, responsive to the user finishing, the companion content may likewise be automatically closed, paused, stopped, or otherwise terminated.

At step 311, the user may be prompted (e.g., via the first device) as to whether the user wishes to update any of the parameters. The parameter values may be displayed and edited as desired. For instance, a user interface of the first device may prompt the user to see if the user would like to update the browser settings for the association (e.g., if the user had changed the browser display dimensions while browsing, has browsed to a different web site now, etc.). Thus, when the user finishes browsing a web site or viewing video content, this may be a good time to determine whether the current browser and/or video window state (e.g., layout such as window size, shape, location) should be updated into the parameters, so that the next time the user browses the web site or views the video content, the parameters will reflect the layout of the last time the user browsed or viewed the web site or the video content. If the user makes any updates or accepts the current layout state, then the parameters may be updated at step 312.

At step 313 (FIG. 3B), the user may decide to record a video program. The video program may be currently transmitted (e.g., broadcast, multicast, unicast) by a service provider (e.g., via TS 104) or is scheduled to be transmitted at a future time. Thus, at step 313, the user may set a device to record the video program currently in progress or to begin recording the program at a particular time in the future. The user may record the video program with the device 113 (e.g., where the device includes a DVR or other recording apparatus) and/or with any other device, and the user may make the request to record using any user interface such as through a program guide or other interface, or by pressing a record button on a remote control while the video program is in progress. In response to a request to record the video program, at step 314 the user may be prompted with a message asking, for instance, if the user would like to also record/store companion content that is already associated with the video program or other primary content and/or primary content source. For example, if the request is to record video program B (referring to Table 1), then the user may be prompted for whether the user would like to store a copy of associated web site B and/or web site C. If so, then at step 315, in addition to scheduling a recording of the video program, the device making the recording may also schedule a task to obtain and stored (archive) the associated web site(s) (in this case, web site B and web site C) at the time that the recording of the video program is performed. For instance, content from web sites B and C may be obtained and stored at a time coinciding with the beginning of recording video program B, at a time coinciding with the end of recording video program B, and/or at any one or more times during the recording of video program B. By way of example, if video program B is scheduled to be transmitted (and thus recorded) from 1:00 pm to 2:00 pm on a particular day, then the content of web sites B and C may be retrieved one or more times at any time during the recording window of 1:00 pm to 2:00 pm. In further embodiments, the web sites B and C may additionally or alternatively be retrieved during a time that is outside the recording window, such as a half hour before, an hour before, a half hour after, and/or an hour after the recording window. These times are only examples—the web sites may be retrieved at any times that are determined based on the scheduled recording window. It may be desirable to capture the web sites outside the recording window in case the user would like to see how the content of those web sites might be altered as a result of the video program being shown. For instance, if the web site includes a bulletin board in which various users may post comments, then the user may be interested in seeing how the bulletin board conversation plays out over time. The parameters (e.g., parameter set B of Table 1) may specify when and/or how often to retrieve and store the associated web site(s).

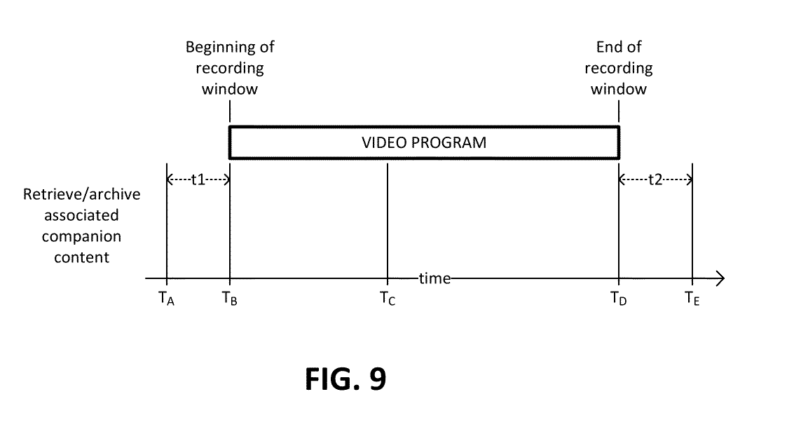

FIG. 9 illustrates an example timeline in which a video program is recorded along with archival of content (e.g., a web site) associated with the video program. In this example, the companion content is archived five times—at times T_{A}, T_{B}, T_{C}, T_{D}, and T_{E}. In other examples, the companion content may be archived only once for a given recording of a video program, or multiple times other than five times, as desired. The various times in FIG. 9 illustrate different example circumstances in which the companion content may be archived. The recording window may be a scheduled recording window with a scheduled start time and/or scheduled end time, or alternatively the recording window may be manually controlled, such as by the user manually starting and/or stopping the recording. In the shown example, time T_{A} occurs t1 amount of time prior to the beginning of the recording window, time T_{B} occurs at or approximately at the beginning of the recording window, time T_{C} occurs sometime during the recording window, time T_{D} occurs at or approximately at the end of the recording window, and time T_{E} occurs t2 amount of time after the recording window ends. Time periods t1 and t2 may be the same or different, and may be any amounts of time, on the order of minutes, hours, or even days. Where the recording window is a scheduled recording window, then during scheduling of the recording, time T_{A} may be calculated by subtracting time period t1 from the scheduled beginning of the recording window, where time period t1 may be a predetermined amount of time and/or an amount of time selected by the user during profile setup or recording setup. Likewise, time T_{E} may be calculated by adding time period t2 to the scheduled end of the recording window, where time period t2 may be a predetermined amount of time and/or an amount of time selected by the user during profile setup or recording setup. Where the recording window is not scheduled (e.g., is manually user-controlled), then time T_{E} may be calculated based on the actual end of the recording window. Also, in cases where the recording window has a scheduled beginning but not end (e.g., where a sports game or other live event is being recorded), and even though the recording window may automatically end without user intervention, then time T_{E} may also be calculated based on the actual end of the recording window.

Time T_{C} may be calculated based, for instance, on the beginning and/or end times of the recording window. For instance, time T_{C} may be determined to be a halfway point, quarter point, or at any other such point through the recording window. Or, time T_{C} may be determined to be at a particular predetermined amount of time delay after the beginning of the recording window and/or prior to the end of the recording window. Moreover, there may be multiple archival times during the recording window. In such a case, the multiple archival times may also be determined in any of the manners discussed above with regard to determining T_{C}, and/or on a random or periodic basis during the recording window. Moreover, the companion content may be archived at any time before, during, and/or after the recording window upon a manual-initiated user command to do so (e.g., via a remote control device). In all of the above examples with reference to FIG. 9, each of the archived versions of the companion content (e.g., at times TA, TB, TC, TD, and TE) may be stored in one or more computer-readable media, such as at the application server 107, a third party device, and/or one or more of the client devices 110-116, and tagged with or otherwise associated with the video program that is recorded. Moreover, the archived versions may be identified in the association information so that the archived versions may be subsequently located and retrieved as desired. For instance, file names and/or directory locations of the files containing the archived versions may be included in the association information.

Where the present disclosure refers to retrieving the content of a web site, this can include retrieving (e.g., browsing to and storing) not just a single page within a web site at a single specific network address (e.g., URL), but also multiple related pages within the web site. For instance, where the web site has multiple pages linked together, the retrieval and archiving of the web page may involve retrieving and archiving each of those pages and/or a subset of those pages as chosen by the user. The device performing the retrieval may utilize a spider program, for example, to discover and retrieve the content from the various linked pages.

At step 316, if it is time to record the video program, then the process moves to step 317 to actually record the video program. And, at step 318, the browser of the appropriate device (which may be specified by parameters such as parameter set B in Table 1) may be instructed to retrieve and store (e.g., archive) the associated sources of companion content (such as one or more web sites, one or more network addresses, etc.) at the appropriate one or more times as discussed above. Then, at the scheduled time(s), the video program is recorded (e.g., to device 113 or personal computer 114), and the one or more associated web sites are retrieved and archived. The content for the retrieved web sites may be archived at the service provider side, such as by application server 107 and/or by a third party, and/or at the client side, such as in computer-readable storage media of any of the client devices 110-116.

At step 319, it may be subsequently determined that the user wishes to play back the recorded video content on a particular device. For instance, device 113 or personal computer 114 may receive a user input indicating a selection to play the recorded video content (e.g., through a program guide interface or other user interface). In response to detecting the request to play back the video program, the process may move to step 320, in which it is determined whether the user desires to also view content (e.g., one or more web sites) associated with the video program. This determination may be based on, for instance, the values of parameters associated with the video program (see, e.g., Table 1), a command from the user to view the companion content, and or a default decision based, for instance, on a predetermined profile for the user and/or device. The parameters for the video program to be played back may have been set, for instance, by the user at the time of scheduling the recording of the video program, and/or as global parameters to be set by default for all recordings. Where a user command at the time of playback is used to make the determination at step 320, then the device receiving the request for playback may prompt the user, through a user interface, as to whether the user desires to display the companion content. The user may then respond to the prompt as desired.

If it is determined that the companion content should be displayed, then the process may move to step 321, in which it is determined, for each item of the companion content as indicated by the association information (see, e.g., Table 1), whether a current version of the companion content or an archived version of the companion content should be displayed. This determination may also be based on, for instance, the values of parameters associated with the video program (see, e.g., Table 1), a command from the user to view new or archived companion content, and or a default decision based, for instance, on a predetermined profile for the user and/or device. Where a user command at the time of playback is used to make the determination at step 321, then the device receiving the request for playback may prompt the user, through a user interface, as to whether the user desires to display a current version of the companion content or an archived version of the companion content. The user may then respond to the prompt as desired.

For each item of the companion content, if it is determined that a current version of the companion content is to be presented, then at step 322, the current version may be retrieved from the source of the content (e.g., from the web site), and presented (e.g., displayed) to the user in accordance with the parameters as described above. For each item of the companion content, if it is determined that an archived version of the companion content is to be presented, then at step 323, one or more archived versions that were previously stored may be retrieved and presented (e.g., displayed) to the user in accordance with the parameters as described above. Thus, at step 323, a version of the companion content may be retrieved and presented, in which the version of companion content is a version that was contemporaneous with (e.g., existed at or near the time of) the recording the video program.

At step 323, any one or more archived versions of the companion content may be selected and presented. For instance, the parameters may indicate which one or more of the archived versions are to be presented. Additionally or alternatively, the user may select from one or more of the archived versions, e.g., from a list presented on a user interface. Where more than one archived version of the companion content exists for the video program being played back, different versions may be presented depending upon the current point in playback of the video program. For example, referring to FIG. 9, if the video program is played back at the beginning, then the version of the companion content archived at time T_{B} may be presented. Later, as playback progresses, the version of the companion content archived at time T_{C} may be presented. And, at or near the end of the played-back video program, the version of the companion content archived at time T_{D} may be presented. Thus, the particular version of archived companion content to be presented at any given time may depend upon the current point in playback of the video program.

In the example embodiments are described above, the various features and steps may be combined, divided, omitted, rearranged, revised and/or augmented in any desired manner, depending on the specific outcome and/or application. Various alterations, modifications, and improvements will readily occur to those skilled in art. Such alterations, modifications, and improvements as are made obvious by this disclosure are intended to be part of this description though not expressly stated herein, and are intended to be within the spirit and scope of the disclosure. Accordingly, the foregoing description is by way of example only, and not limiting.

Moreover, while particular types of content and companion content have been described, these are merely examples. Any type of content and/or content source, as the terms are broadly construed, may be associated with any other one or more types of content and/or content source. For instance, while many of the examples herein refer to associating a web site with a video program, other combinations of content may be associated with one another, such as but not limited to any of the following: video content (with or without audio content), audio content, web site content, graphical content, textual content, image content, advertisements, animation, hyperlinks, data files, live data feeds, device and/or sensor status information, favorite channels, device settings, video games, other software, defined movements of a mechanical device and/or robot, etc. And, while various examples discuss displaying content such as video content and web site content, any of these instances may include other types of content presentation (depending upon the type of content), such as but not limited to displaying video, generating sound for audio content, executing video games or other software, opening files, interpreting/decoding text or other information for presentation suitable for viewing and/or hearing by a user, causing content to be presented as animated, tuning to a channel, adjusting device settings, and/or causing one or more mechanical and/or robotic devices to operate.

What is claimed is:

1. A method, comprising:
establishing an association between a first item of content and a second item of content;
receiving a first version of the second item of content; and
responsive to a user request for the first item of content, causing, by at least one computing device, both the first item of content and the first version of the second item of content to be presented.

2. The method of claim 1, wherein the second item of content is web site content.

3. The method of claim 2, wherein the first item of content is video content.

4. The method of claim 1, wherein the causing comprises causing the first item of content to be presented by a first device and the first version of the second item of content to be presented by a different second device.

5. The method of claim 4, wherein the at least one computing device comprises one of the first device or the second device.

6. The method of claim 1, wherein the causing comprises causing both the first item of content and the first version of the second item of content to be displayed.

7. The method of claim 1, further comprising:
establishing an association between a third item of content and the second item of content;
receiving a second version of the second item of content different from the first version of the second item of content; and
responsive to a user request for the third item of content, causing both the third item of content and the second version of the second item of content to be presented.

8. The method of claim 7, wherein the first item of content is a first episode of a video program series and the third item of content is a second episode of the video program series.

9. The method of claim 1, further comprising recording the first item of content, wherein the receiving comprises receiving and storing the first version of the second item of content as it exists during the recording of the first item of content, and wherein the causing the first item of content to be presented comprises causing the first item of content as recorded to be presented.

10. A method, comprising:
recording a first item of video content;
determining that an association exists between the first item of video content and a content source;
obtaining first companion content from the content source while the first item of video content is being recorded; and
responsive to a user request for the first item of video content, causing, by at least one computing device, both the first item of video content and the first companion content to be presented.

11. The method of claim 10, further comprising:
recording a second item of video content;
determining that an association exists between the second item of video content and the content source;
obtaining second companion content from the content source, different from the first companion content, while the second item of video content is being recorded; and
responsive to a user request for the second item of video content, causing, by at least one computing device, both the second item of video content and the second companion content to be presented.

12. The method of claim 10, wherein the causing comprises causing the first item of video content to be presented by a first device and the first companion content to be presented by a different second device.

13. The method of claim 12, wherein the at least one computing device comprises one of the first device or the second device.

14. The method of claim 10, wherein the causing comprises causing both the first item of video content and the first companion content to be displayed.

15. The method of claim 10, wherein the causing comprises causing the first item of video content to be displayed on a first portion of a display while the first companion content is displayed on a second portion of the display.

16. A method, comprising:
responsive to receiving user input identifying video content to be associated with a network address, generating profile information associating the network address and the video content; and
responsive to accessing the network address:
using, by at least one computing device, the profile information to obtain the video content, and
causing the video content that was obtained to be presented.

17. The method of claim 16, wherein the causing comprises causing the video content to be presented by a first device and content obtained from the network address to be presented by a different second device.

18. The method of claim 17, wherein the at least one computing device comprises one of the first device or the second device.

19. The method of claim 16, wherein the causing comprises causing content obtained from the network address to be displayed on a first portion of a display while the video content is displayed on a second portion of the display.

20. The method of claim 16, wherein the network address comprises a network address of a web site, wherein the user input is received while the user is browsing the web site, and wherein the using is performed responsive to subsequently browsing the web site.
